(19) United States
(12) Patent Application Publication
(10) Pub. No.: US 2023/0009135 A1
(43) Pub. Date: Jan. 12, 2023

(54) TIRE

(71) Applicant: The Yokohama Rubber Co., LTD., Tokyo (JP)

(72) Inventor: Hiroki ENDO, Kanagawa (JP)

(21) Appl. No.: 17/810,758

(22) Filed: Jul. 5, 2022

(30) Foreign Application Priority Data
Jul. 9, 2021 (JP) 2021-114317
Jun. 10, 2022 (JP) 2022-094656

(51) Int. Cl. B60C 13/00; B60C 13/02

(52) U.S. Cl. CPC B60C 13/002; B60C 13/02; B60C 2200/14

(57) ABSTRACT

A tire includes a plurality of side blocks arrayed at a predetermined interval in a tire circumferential direction in a buttress portion. The side blocks include a short portion and a long portion arrayed in a Y shape and a slit that defines a connection portion of the short portion and the long portion and are disposed with a top portion of the Y shape facing toward an inner side in a tire radial direction. A radial height Hb of the side blocks is in the range 0.20≤Hb/SH≤0.50 with respect to a tire cross-sectional height SH.

### RELATED APPLICATION

This application is based upon and claims the benefit of priority from Japan Patent Application No. JP 2021-114317 filed on Jul. 9, 2021 and Japan Patent Application No. 2022-094656 filed on Jun. 10, 2022, the entire contents of each of which is incorporated herein by reference.

### TECHNICAL FIELD

The technology relates to a tire and particularly relates to a tire that can provide mud performance and cut resistance performance of the tire in a compatible manner.

### BACKGROUND ART

For a known all-season tire to be mounted on, for example, a pickup truck and a sport utility vehicle (SUV), there is a demand for increasing tire off-road performance. Technology described in Japan Patent No. 6686446 B is a known tire in the related art associated with such a problem.

### SUMMARY

The technology provides a tire that can provide mud performance and cut resistance performance of the tire in a compatible manner.

A tire according to an embodiment of the technology includes a plurality of side blocks arrayed at a predetermined interval in a tire circumferential direction in a buttress portion, the side blocks include a short portion and a long portion arrayed in a Y shape and a slit that defines a connection portion of the short portion and the long portion and are disposed with a top portion of the Y shape facing toward an inner side in a tire radial direction.

In the tire according to an embodiment of the technology, (1) in a plan view of the buttress portion, a side block has a Y shape formed of a short portion and a long portion, and thus a total length of an edge portion of the side block increases compared to a configuration in which the side block is formed of a pair of small blocks having the same length (so-called V shape), improving the mud discharge effect of the side block to improve the tire mud performance. Additionally, the rigidity of the side block in the tire circumferential direction is reinforced by the long portion, improving the cut resistance performance of the tire. Furthermore, (2) the slit defines the connection portion of the short portion and the long portion and penetrates the side block, and thus discharge of mud entering the Y-shaped bifurcated portion of the side block is promoted when the tire is rolling, improving the tire mud performance. This has an advantage of providing the mud performance and cut resistance performance of the tire in a compatible manner.

### BRIEF DESCRIPTION OF DRAWINGS

FIG. 1 is a cross-sectional view in a tire meridian direction illustrating a tire according to an embodiment of the technology.

FIG. 2 is a plan view illustrating a tread surface of the tire illustrated in FIG. 1.

FIG. 3 is an enlarged view illustrating the shoulder land portion illustrated in FIG. 2.

FIG. 4 is an enlarged view illustrating a shoulder portion of the tire illustrated in FIG. 1.

FIG. 5 is a plan view illustrating a buttress portion of the tire illustrated in FIG. 4.

FIG. 6 is an enlarged view illustrating a side block illustrated in FIG. 5.

FIG. 7 is a table showing the results of performance tests of tires according to an embodiment of the technology.

FIG. 8 is a table showing the results of performance tests of tires according to embodiments of the technology.

FIG. 9 is a table showing the results of performance tests of tires according to embodiments of the technology.

### DETAILED DESCRIPTION

Embodiments of the technology will be described in detail below with reference to the drawings. Note that the technology is not limited to the embodiments. Additionally, constituents of the embodiments include constituents that are substitutable and are obviously substitutes while maintaining consistency with the embodiments of the technology. Additionally, a plurality of modified examples described in the embodiments can be combined in a discretionary manner within the scope apparent to one skilled in the art.

### Tire

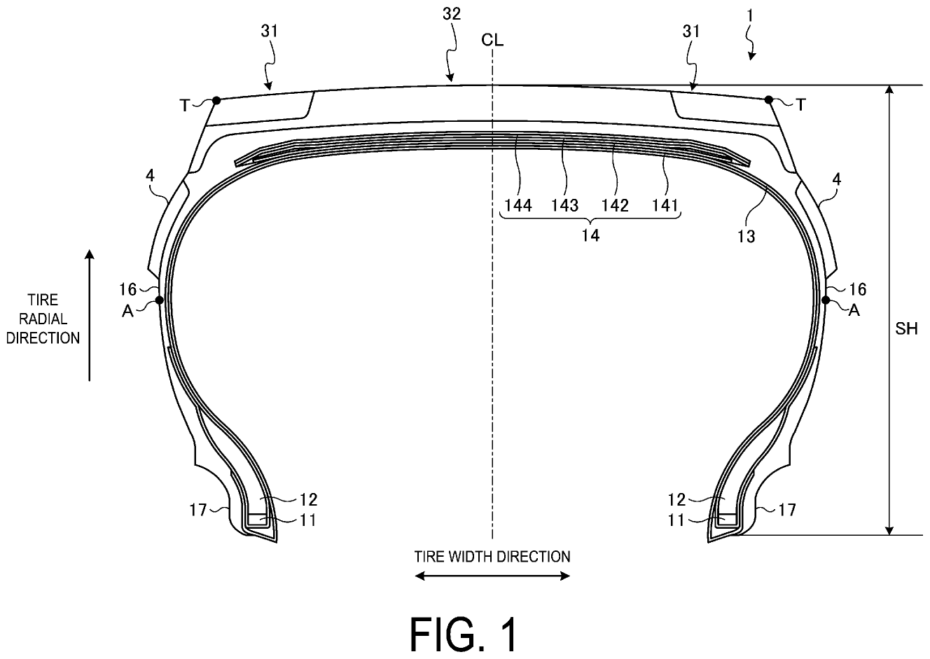

FIG. 1 is a cross-sectional view in a tire meridian direction illustrating a tire 1 according to an embodiment of the technology. The same drawing illustrates a cross-sectional view of a half region in a tire radial direction. Further, the same drawing also illustrates a pneumatic radial tire for a light truck as an example of a tire.

In the same drawing, a cross-section in the tire meridian direction is defined as a cross-section of the tire taken along a plane that includes a tire rotation axis (not illustrated). Further, a tire equatorial plane CL is defined as a plane perpendicular to the tire rotation axis through a midpoint between measurement points in a tire cross-sectional width defined by JATMA (The Japan Automobile Tyre Manufacturers Association, Inc.). Additionally, a tire width direction is defined as a direction parallel to the tire rotation axis, and the tire radial direction is defined as a direction perpendicular to the tire rotation axis.

The tire 1 includes an annular structure with the tire rotation axis being as the center, and includes a pair of bead cores 11, 11, a pair of bead fillers 12, 12, a carcass layer 13, a belt layer 14, a tread rubber 15, a pair of sidewall rubbers 16, 16, and a pair of rim cushion rubbers 17, 17 (see FIG. 1).

The pair of bead cores 11, 11 each include one or more of bead wires made of steel and made by being wound annularly multiple times, and the pair of bead cores 11, 11 are embedded in bead portions and constitute cores of the bead portions of left and right. The pair of bead fillers 12, 12 are respectively disposed on an outer circumference of the pair of bead cores 11, 11 in the tire radial direction and reinforce the bead portions.

The carcass layer 13 has a single layer structure including one carcass ply, or a multilayer structure including a plurality of carcass plies being layered, and the carcass layer 13 extends in a toroidal shape between the bead cores 11, 11 at the left and right, and constitutes the backbone of the tire. Additionally, both end portions of the carcass layer 13 are turned back toward outer sides in the tire width direction to wrap the bead cores 11 and the bead fillers 12, and are fixed. Moreover, the carcass ply of the carcass layer 13 is made by covering a plurality of carcass cords made of steel or an organic fiber material (for example, aramid, nylon, polyester, rayon, or the like) with a coating rubber and performing a rolling process on the carcass cords, and has a cord angle (defined as an inclination angle in a longitudinal direction of the carcass cords with respect to a tire circumferential direction) of 80 degrees or more and 100 degrees or less.

The belt layer 14 is made of a plurality of belt plies 141 to 144 being layered and is disposed around an outer circumference of the carcass layer 13. The belt plies 141 to 144 include a pair of cross belts 141, 142 and a plurality of belt covers 143, 144.

The pair of cross belts 141, 142 are made by covering a plurality of belt cords made of steel or an organic fiber material with a coating rubber and performing a rolling process on the belt cords, and have a cord angle of 15 degrees or more and 55 degrees or less as an absolute value. Further, the pair of cross belts 141, 142 have cord angles (defined as inclination angles in longitudinal directions of the belt cords with respect to the tire circumferential direction) of mutually opposite signs and are layered such that the longitudinal directions of the belt cords intersect each other (so-called crossply structure). Furthermore, the pair of cross belts 141, 142 are disposed in a layered manner on an outer side in the tire radial direction of the carcass layer 13.

The belt covers 143, 144 are made by coating belt cover cords made from steel or an organic fiber material with a coating rubber and has a cord angle, as an absolute value, of 0 degrees or more and 10 degrees or less. Additionally, the belt covers 143, 144 are, for example, strip materials formed by coating one or a plurality of belt cover cords with a coating rubber, where the strip material is formed by winding the strip material spirally on the outer circumferential surfaces of the cross belts 141, 142 multiple times in the tire circumferential direction. Additionally, the plurality of belt covers 143, 144 are disposed covering all the cross belts 141, 142.

The tread rubber 15 is disposed in the outer circumferences in the tire radial direction of the carcass layer 13 and the belt layer 14 and constitutes a tread portion of the tire. The pair of sidewall rubbers 16, 16 are disposed on an outer side in the tire width direction of the carcass layer 13 and constitute sidewall portions of left and right, respectively. The pair of rim cushion rubbers 17, 17 extend from an inner side in the tire radial direction of the bead cores 11, 11 of left and right and turned back portions of the carcass layer 13 toward the outer side in the tire width direction, and constitute rim fitting surfaces of the bead portions.

### Tread Pattern

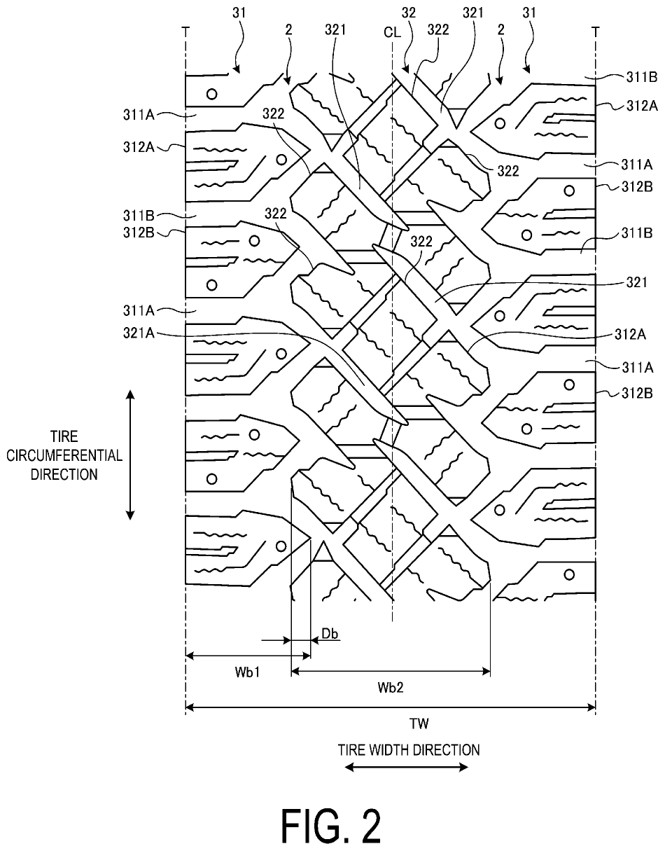

FIG. 2 is a plan view illustrating a tread surface of the tire 1 illustrated in FIG. 1. The same drawing illustrates a tread surface of an off-road tire. In the same drawing, “tire circumferential direction” refers to the direction about the tire rotation axis. Additionally, reference sign T denotes a tire ground contact edge, and dimension symbol TW denotes a tire ground contact width.

As illustrated in FIG. 2, the tire 1 includes, in the tread surface, a pair of circumferential main grooves 2, and a pair of shoulder land portions 31 and one center land portion 32 that are defined and formed by these circumferential main grooves 2.

The circumferential main groove 2 has a zigzag shape having an amplitude in the tire width direction. Further, the circumferential main groove 2 refers to a groove on which a wear indicator must be provided as specified by JATMA, and has a maximum groove width of 7.0 mm or more and a maximum groove depth of 8.0 mm or more.

The groove width is measured as a distance between groove walls opposed to each other in a groove opening portion when the tire is mounted on a specified rim, inflated to a specified internal pressure, and in an unloaded state. In a configuration in which the groove opening portion includes a notch portion or a chamfered portion, the groove width is measured with intersection points between an extension line of the tread contact surface and extension lines of the groove walls as measurement points, in a cross-sectional view parallel with the groove width direction and the groove depth direction.

The groove depth is measured as a distance from the tread contact surface to a groove bottom when the tire is mounted on a specified rim, inflated to a specified internal pressure, and in an unloaded state. Additionally, in a configuration in which a groove bottom includes partial recess/protrusion portions or a sipe, the groove depth is measured excluding the partial recess/protrusion portions or the sipe.

“Specified rim” refers to a “standard rim” defined by JATMA, a “Design Rim” defined by the Tire and Rim Association, Inc. (TRA), or a “Measuring Rim” defined by the European Tyre and Rim Technical Organisation (ETRTO). Additionally, the specified internal pressure refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. Additionally, the specified load refers to a “maximum load capacity” specified by JATMA, the maximum value in “TIRE LOAD LIMITS AT VARIOUS COLD INFLATION PRESSURES” specified by TRA, or “LOAD CAPACITY” specified by ETRTO. However, in JATMA, in the case of a tire for a passenger vehicle, the specified internal pressure is an air pressure of 180 kPa, and the specified load is 88% of the maximum load capacity at the specified internal pressure.

Additionally, in FIG. 2, a maximum ground contact width Wb1 of the shoulder land portion 31 is preferably in the range 0.25≤Wb1/TW≤0.40 and more preferably in the range 0.27≤Wb1/TW≤0.35 with respect to the tire ground contact width TW.

In addition, a maximum ground contact width Wb2 of the center land portion 32 is preferably in the range 0.30≤Wb2/TW≤0.60, and more preferably in the range 0.40≤Wb2/TW≤0.50, with respect to the tire ground contact width TW.

The ground contact widths of the land portions are each measured as a linear distance in the tire axial direction in a contact surface of the land portion and a flat plate, when the tire is mounted on a specified rim, inflated to a specified internal pressure, placed perpendicular to the flat plate in a static state, and subjected to a load corresponding to a specified load.

The tire ground contact width TW is measured as a linear distance in the tire axial direction of a contact surface of the tire and a flat plate when the tire is mounted on a specified rim, inflated to a specified internal pressure, placed perpendicular to the flat plate in a static state, and subjected to a load corresponding to a specified load.

A tire ground contact edge T is defined as a maximum width position in the tire axial direction of the contact surface between the tire and a flat plate when the tire is mounted on a specified rim, inflated to a specified internal pressure, placed perpendicular to the flat plate in a static state, and loaded with a load corresponding to a specified load.

Further, as illustrated in FIG. 2, the pair of shoulder land portions 31 and the center land portion 32 are arranged so as to overlap each other when viewed in the tire circumferential direction. Accordingly, the circumferential main groove 2 has the see-through-less structure when viewed in the tire circumferential direction.

Further, an overlap amount Db between the shoulder land portion 31 and the center land portion 32 has the relationship 0≤Db/TW≤0.10 with respect to the tire ground contact width TW.

The overlap amount Db of the land portions 31, 32 is measured as a distance in the tire width direction of measurement points of the maximum ground contact widths Wb1, Wb2 of the land portions 31, 32.

### Shoulder Land Portion

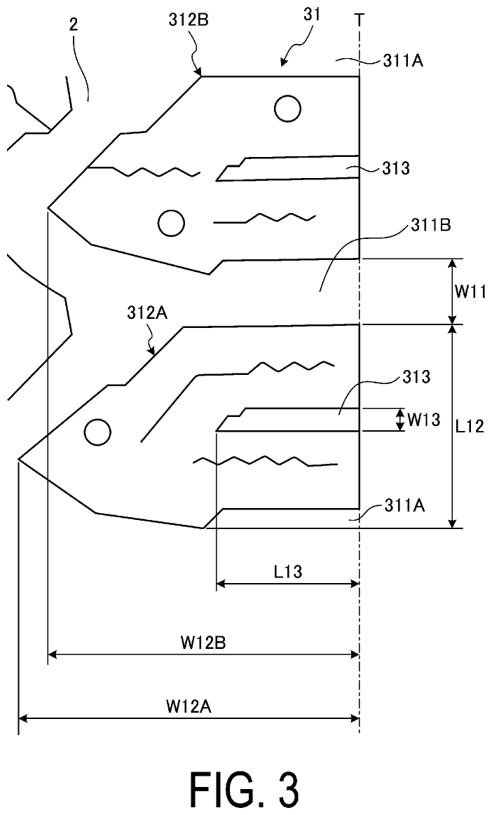

FIG. 3 is an enlarged view illustrating the shoulder land portion 31 illustrated in FIG. 2.

As illustrated in FIGS. 2 and 3, the shoulder land portion 31 includes a plurality of shoulder lug grooves 311A, 311B and a plurality of shoulder blocks 312A, 312B defined by these shoulder lug grooves 311A, 311B.

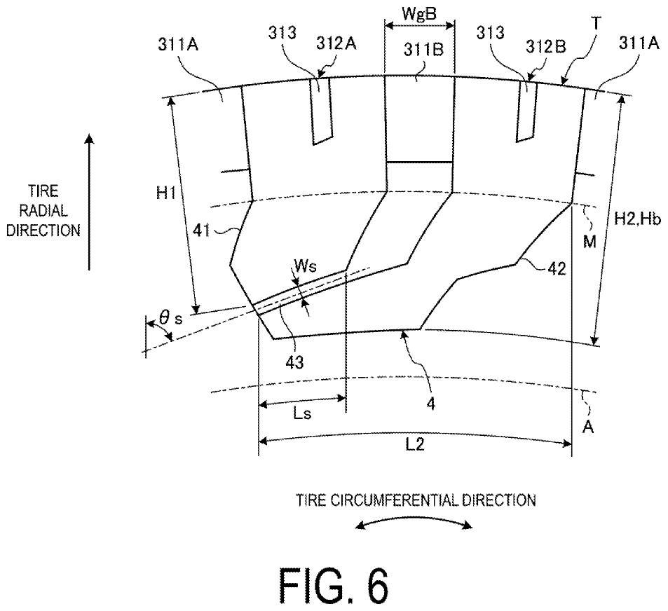

The shoulder lug grooves 311A, 311B extend in the tire width direction and open to the circumferential main groove 2 at one end and open to the tire ground contact edge Tat the other end. Additionally, a plurality of the shoulder lug grooves 311A, 311B are arrayed at a predetermined interval in the tire circumferential direction. Moreover, the shoulder lug grooves 311A, 311B have a groove width W11 (see FIG. 3) of 13 mm or more and a groove depth H11 (see FIG. 6 described below) of 8.0 mm or more. In addition, the groove depth H11 of the shoulder lug grooves 311A, 311B is in the range 0.80≤H11/Hm≤1.00 with respect to the groove depth Hm (not illustrated) of the circumferential main groove 2. Moreover, in the configuration of FIG. 2, the first and second lug grooves 311A, 311B having mutually different shapes are alternately arrayed in the tire circumferential direction. Further, the total number of shoulder lug grooves 311A, 311B is the same as the number of zigzag-shaped pitches of the circumferential main groove 2, and these shoulder lug grooves 311A, 311B are each open to maximum amplitude positions of the circumferential main groove 2, to the outer side in the tire width direction.

The shoulder blocks 312A, 312B include a protruding edge portion that protrudes toward the tire equatorial plane CL side along the zigzag shape of the circumferential main groove 2 (see FIG. 2). Additionally, the plurality of shoulder blocks 312A, 312B are arrayed at a predetermined interval in the tire circumferential direction to form a single block row. Further, in the configuration of FIG. 2, the first and second shoulder blocks 312A, 312B having mutually different shapes are alternately arrayed in the tire circumferential direction. Further, the total number of shoulder blocks 312A, 312B is the same as the number of zigzag-shaped pitches of the circumferential main groove 2.

Furthermore, in FIG. 3, the width W12 (W12A, W12B) of the shoulder blocks 312A, 312B is in the range 0.80≤W12/L12≤2.20 with respect to a circumferential length L12 of the shoulder blocks 312A, 312B, and preferably in the range 1.30≤W12/L12≤1.80. Accordingly, the rigidity of the shoulder blocks 312A, 312B is appropriately ensured. Additionally, in the configuration of FIG. 3, the width W12A of the elongated first shoulder block 312A corresponds to the ground contact width Wb1 of the shoulder land portion 31 when the tire comes into contact with the ground. Further, the ground contact width W12B of the short second shoulder block 312B is in the range 0.70≤W12B/W12A≤1.00 with respect to the width W12A of the first shoulder block 312A.

The circumferential length L12 of the shoulder blocks 312A, 312B is the maximum distance of the extension length of the block in the tire circumferential direction, and is measured when the tire is mounted on a specified rim, inflated to a specified internal pressure, and in an unloaded state.

The widths W12A, W12B of the shoulder blocks 312A, 312B are the maximum distances of the extension lengths of the blocks in the tire width direction, and are measured when the tire is mounted on a specified rim, inflated to a specified internal pressure, and in an unloaded state.

Furthermore, as illustrated in FIG. 3, each of the shoulder blocks 312A, 312B includes a shoulder narrow groove 313. The shoulder narrow groove 313 terminates inside the shoulder blocks 312A, 312B at one end and opens to the tire ground contact edge Tat the other end. Additionally, the groove width W13 of the shoulder narrow groove 313 is in the range 0.05≤W13/W11≤0.50 with respect to the groove width W11 of the shoulder lug grooves 311A, 311B, and is preferably in the range 0.15≤W13/W11≤0.40. Additionally, the groove width W13 of the shoulder narrow groove 313 is in the range of 0.8 mm or more and 10 mm or less. Moreover, an extension length L13 in the tire width direction of the shoulder narrow groove 313 is in the range 0.40≤L13/W12≤0.80 with respect to the width W12 (W12A, W12B) of the shoulder blocks 312A, 312B, and is preferably in the range 0.50≤L13/W12≤0.70. In the configuration of in FIG. 3, each of the shoulder blocks 312A, 312B has a V-shape defined and formed by the shoulder narrow groove 313, and is disposed with the top portion of the V-shape toward the tire equatorial plane CL side.

Note that in the configuration of FIG. 3, each of the shoulder blocks 312A, 312B includes a plurality of sipes (reference sign omitted in drawings), and a pin hole for inserting a studless pin (reference sign omitted in drawing).

### Center Land Portion

As illustrated in FIG. 2, the center land portion 32 includes a plurality of inclined main grooves 321, a plurality of lateral grooves or auxiliary grooves (reference sign omitted in the drawings), and a plurality of center blocks 322 defined by these grooves.

As illustrated in FIG. 2, the inclined main groove 321 inclines to the tire circumferential direction and extends therein, and intersects the tire equatorial plane CL. Further, the inclined main groove 321 opens to the circumferential main groove 2 at one end and terminates in the center land portion 32 at the other end. Further, the left and right inclined main grooves 321, 321 mutually incline in the same direction with respect to the tire circumferential direction and extend therein, and open to the left and right circumferential main grooves 2, 2. Moreover, the inclined main groove 321 has a groove width of 5.0 mm or more and a groove depth of 8.0 mm or more. In the configuration of FIG. 2, the inclined main groove 321 has the same maximum groove depth with respect to the circumferential main groove 2. Furthermore, the inclination angle (dimension symbol omitted in the drawings) of the inclined main groove 321 with respect to the tire equatorial plane CL is in the range of 25 degrees or more and 70 degrees or less.

The inclination angle of the inclined main groove 321 is measured as an angle between the groove center line of the inclined main groove 321 and the tire equatorial plane CL.

The center block 322 includes a protruding edge portion that protrudes toward the tire ground contact edge T side along the zigzag shape of the circumferential main groove 2. Additionally, the plurality of center blocks 322 are arranged at a predetermined interval in the tire circumferential direction. Further, in the configuration of FIG. 2, the same number of center blocks 322 as the number of zigzag-shaped pitches of the circumferential main groove 2 are arranged along the circumferential main groove 2 in the tire circumferential direction. Furthermore, each of the center blocks 322 includes a plurality of sipes (reference sign omitted in the drawings).

### Side Block

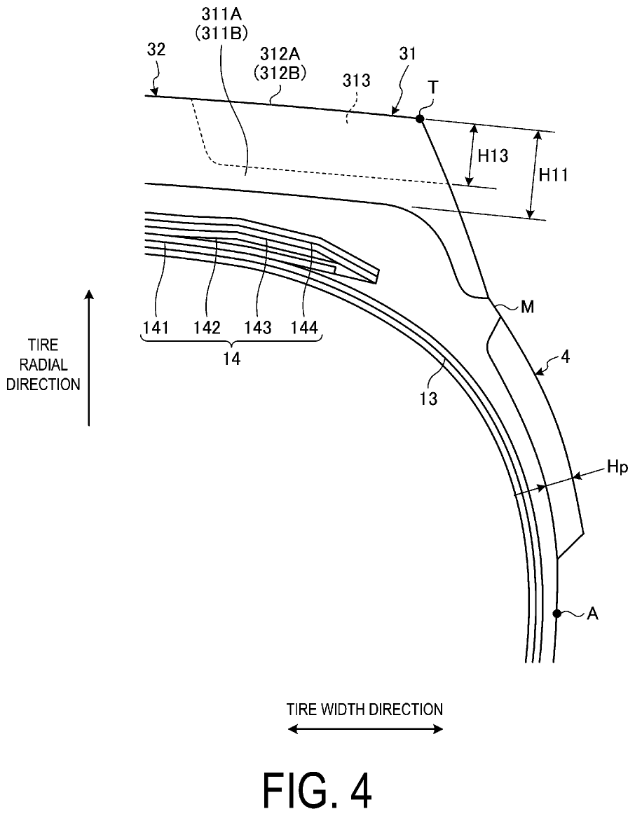

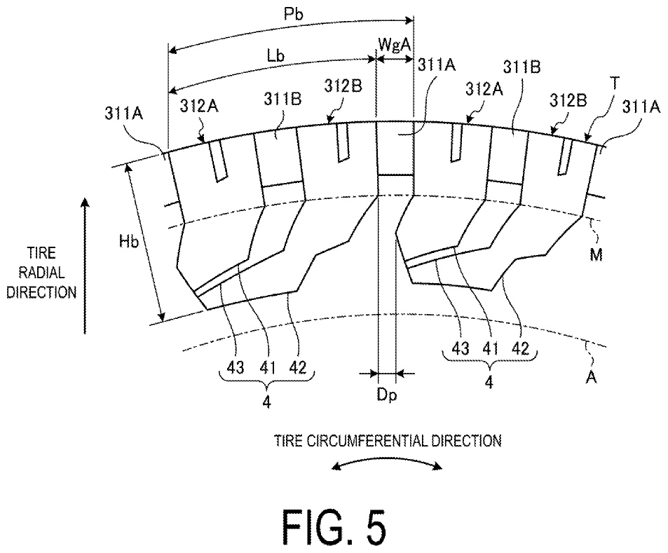

FIG. 4 is an enlarged view illustrating a shoulder portion of the tire 1 illustrated in FIG. 1. FIG. 5 is a plan view illustrating a buttress portion of the tire 1 illustrated in FIG. 4. FIG. 6 is an enlarged view illustrating a side block 4 illustrated in FIG. 5.

As illustrated in FIGS. 1 and 4, the tire 1 includes the side block 4 in the buttress portion. The side block 4 is a protrusion portion protruding from the side profile of the tire to the tire outer surface, and primarily has (1) a function of protecting the tire side portion from an external damage and increasing the cut resistance of the tire and (2) a function of improving the mud discharge properties of the buttress portion and increasing the mud performance of the tire.

The buttress portion is defined as a non-ground contacting region formed in a connection portion between the profile of the tread portion and the profile of the sidewall portion, and configures a sidewall surface on an outer side in the tire width direction of the shoulder land portion 31.

The side profile is a contour line that approximates the outer surface of the sidewall from the bead portion to the buttress portion in a cross-sectional view in the tire meridian direction with a smooth arc, and is defined excluding the recess/protrusion portion formed in the tire side portion (partial protrusion portion such as the side block 4 and a split position M of the mold in FIG. 4).

The tire profile is a contour line of the tire in a cross-sectional view along the tire meridian direction, and is measured using a laser profiler. The laser profiler used may be, for example, a tire profile measuring device (available from Matsuo Co., Ltd.).

For example, in the configuration of FIG. 4, the side block 4 extends from the buttress portion to the inner side in the tire radial direction beyond the split position M of the mold and terminates at the outer side in the tire radial direction from a maximum width position A of the side profile. Additionally, the side block 4 has the same height as the split position M of the mold, and has a trapezoidal cross-section having a constant height in a region on the inner side in the tire radial direction from the split position M of the mold. Additionally, the height of the side block 4 gradually decreases from the split position M of the mold toward the outer side in the tire radial direction so that the side block 4 is smoothly connected to the tire ground contact edge T.

The split position M of the mold is defined as a position corresponding to the connection portion of the split mold of the tire mold. A rib-shaped projection having a width of approximately 2 mm to 3 mm is formed by residual rubber that is caught when molding the tire vulcanization at the split position M. For example, in the configuration of FIG. 4, the split mold is formed of a first mold that advances/withdraws in the tire radial direction to form a tread portion and left and right second molds that advance/withdraw in the tire axial direction to form a side portion (not illustrated), so that the split position M of the mold is formed in the buttress portion of the tire. However, no such limitation is intended, and in the configuration in which the split mold of the tire mold is divided into two in the tire width direction (not illustrated), the split position M of the mold is not formed in the tire side portion, and is formed on the tread surface. In this case, the split position M of the mold in FIG. 4 is omitted.

Additionally, a height Hp of the side block 4 is in the range 3.0 mm≤HP≤10 mm. The lower limit described above ensures the effect of improving the cut resistance and the mud performance of the tire by the side block 4 described above. The upper limit described above prevents a decrease in the degree of freedom of tire deformation due to the side block 4 becoming excessively large, ensuring the ground contact characteristics of the tire.

The maximum height Hp of the side block 4 is measured as the maximum value of the projection height from the side profile to the top surface of the side block 4.

Further, as illustrated in FIG. 5, a plurality of side blocks 4 are arrayed with a predetermined pitch length Pb across the entire circumference of the tire. One side block 4 is configured as a set of a short portion 41 and a long portion 42 described below and is formed across a pair of adjacent shoulder blocks 312A, 312B (see FIGS. 2 and 3). Accordingly, the pitch number of the side block 4 is half of the total number of the shoulder blocks 312A, 312B.

Additionally, in FIG. 5, a circumferential length Lb of the side block 4 at the tire ground contact edge Tis in the range 0.50≤Lb/Pb≤1.00 with respect to the pitch length Pb of the side block 4 and is preferably in the range 0.70≤Lb/Pb≤0.95. The lower limit described above ensures the circumferential length Lb of the side block 4, ensuring the effect of improving the cut resistance and the mud discharge properties by the side block 4. Additionally, the upper limit described above prevents a decrease in the degree of freedom of tire deformation due to the side block 4 becoming excessively large, ensuring the ground contact characteristics of the tire.

The circumferential length Lb of the side block 4 is the extension length of one side block 4 in the tire circumferential direction on the tire ground contact edge T and is measured in a plan view of the buttress portion. In the configuration of FIG. 5, the side block 4 is connected at the tire ground contact edge T with respect to the pair of shoulder blocks 312A, 312B (see FIG. 3), and thus the circumferential length Lb of the side block 4 is measured with the edge portions of the shoulder blocks 312A, 312B at the tire ground contact edge T (see FIG. 2) as end points. Additionally, for example, in a configuration (not illustrated) in which the end portion on the outer side in the radial direction of the side blocks 4 is separated from the tire ground contact edge T, the intersection point of an extension line of the end portion on the outer side in the radial direction of the side block 4 and the tire ground contact edge T is made in a plan view of the buttress portion, and the circumferential length Lb of the side block 4 is measured with this intersection point as the end point.

The pitch length Pb of the side blocks 4 is also measured on the tire ground contact edge T.

Additionally, in FIG. 5, a radial height Hb of the side block 4 in the tire side portion is in the range 0.20≤Hb/SH≤0.50 with respect to a tire cross-sectional height SH (see FIG. 1) and is preferably in the range 0.30≤Hb/SH≤0.45. The lower limit described above ensures the radial height Hb of the side block 4, ensuring the effect of improving the cut resistance and the mud discharge properties by the side block 4. Additionally, the upper limit described above prevents a decrease in the degree of freedom of tire deformation due to the side block 4 becoming excessively large, ensuring the ground contact characteristics of the tire.

A radial height Hb of the side block 4 is the maximum value of the extension length of the side block 4 in the tire radial direction and is measured in a plan view of the buttress portion. In the configuration of FIG. 5, as described above, the end portion of the side block 4 on the outer side in the radial direction is connected to the tire ground contact edge T, and the end portion of the side block 4 on the inner side in the radial direction is on the outer side in the tire radial direction from the maximum width position A of the side profile.

Additionally, in FIG. 5, the circumferential length Lb of the side block 4 at the tire ground contact edge Tis in the range 0.70≤Lb/Hb≤1.50 with respect to the radial height Hb of the side block 4 in the tire side portion and is preferably in the range 0.80≤Lb/Hb≤1.40. This properly sets the aspect ratio of the side block, ensuring the effect of improving the cut resistance and the mud performance of the tire by the side block 4.

Additionally, in FIG. 5, a circumferential distance Dp of adjacent side blocks 4, 4 is in the range 0.10≤Dp/WgA≤1.00 with respect to a groove width WgA of the lug groove (extension portion of the shoulder lug groove 311A in FIG. 5) defining the adjacent side blocks 4, 4 and is preferably in the range 0.30≤Dp/WgA≤0.80. The lower limit described above ensures the circumferential distance Dp of the side block 4, ensuring the effect of improving the cut resistance and the mud discharge properties by the side block 4. Furthermore, the upper limit described above prevents a decrease in the degree of freedom of tire deformation due to the side block 4 becoming excessively large, ensuring the ground contact characteristics of the tire.

The circumferential distance Dp of the side blocks 4, 4 is measured is with the maximum protrusion positions of the adjacent side blocks 4, 4 in the tire circumferential direction as end points.

The groove width WgA of the lug groove defining the adjacent side blocks 4, 4 is measured with the corners of the side blocks 4, 4 on the outer side in the tire radial direction as end points. In a configuration in which the lug groove includes a partial notch portion or a chamfered portion on the tire ground contact edge T (not illustrated), the groove width is measured with intersection points between an extension line of the top surface of the side block and extension lines of the groove walls as measurement points, in a cross-sectional view parallel with the groove width direction and the groove depth direction. Note that, in the configuration of FIG. 5, the side block 4 extends to the tire ground contact edge T, thus the groove width WgA is equal to the groove width W11 (see FIG. 3) of the shoulder lug groove 311A at the tire ground contact edge T.

Further, as illustrated in FIG. 5, one side block 4 has a Y-shaped contour line as a whole. Specifically, the side block 4 consists of the short portion 41 and the long portion 42 (in other words, short small block and long small block), and these small blocks are arrayed in a Y shape so as to configure one side block 4. Additionally, the side block 4 is disposed with a Y-shaped top portion facing toward the inner side in the tire radial direction and a Y-shaped bifurcated portion facing toward the outer side in the tire radial direction.

The Y shape of the side block 4 is recognized by a contour line of a block combining the short portion 41 and the long portion 42 described below. Additionally, the contour line is made excluding partial notch portions, narrow grooves, sipes, recess/protrusion portions, surface processing formed in the short portion 41 and the long portion 42 in a plan view of the tire side portion. Specifically, in the configuration of FIG. 5, the shoulder narrow groove 313 (see FIGS. 3 and 6) and a slit 43 described below do not constitute the Y-shaped contour line of the side block 4. Note that the side block 4 may have the partial notch portions, narrow grooves, sipes, recess/protrusion portions, surface processing described above (not illustrated).

For example, in the configuration of FIG. 5, each of the short portion 41 and the long portion 42 is connected to the tire ground contact edge T, extends in the inner side in the tire radial direction beyond the split position M of the mold, and terminates without reaching the maximum width position A of the side profile. Additionally, the shoulder lug grooves 311A, 311B (see FIG. 2) extend to the buttress portion, and thus the short portion 41 and the long portion 42 are defined by the extension portions of these shoulder lug grooves 311A, 311B. Specifically, the short portion 41 is defined by the extension portions of the adjacent shoulder lug grooves 311A, 311B, and the long portion 42 is defined by the extension portions of the adjacent shoulder lug grooves 311B, 311A.

Additionally, as illustrated in FIG. 5, the long portion 42 has a shape curved or bent in one direction in the tire circumferential direction (left side in FIG. 5) from the tire ground contact edge T toward the inner side in the tire radial direction. Additionally, the short portion 41 has a shape curved or bent in the same direction as the long portion 42 from the tire ground contact edge T toward the inner side in the tire radial direction. In other words, the extension portions of the shoulder lug grooves 311A, 311B are curved or bent in one direction in the tire circumferential direction from the tire ground contact edge T toward the inner side in the tire radial direction, and thus the short portion 41 and the long portion 42 are curved or bent in one direction in the tire circumferential direction. Accordingly, the Y-shaped top portion of the side block 4 is unevenly distributed in one direction in the tire circumferential direction with respect to the bifurcated portion.

In the configuration described above, in a plan view of the buttress portion, the side block 4 has a Y shape formed of the short portion 41 and the long portion 42, and thus the total length of the edge portion of the side block 4 increases compared to the configuration in which the side block is formed of a pair of small blocks having the same length (so-called V shape, which is not illustrated), improving the mud discharge effect of the side block 4 to improve the tire mud performance. Further, the rigidity of the tire side portion in the tire circumferential direction is reinforced by the long portion 42, improving the cut resistance performance of the tire.

Furthermore, in FIG. 6, a circumferential length L2 of the long portion 42 is in the range 0.80≤L2/Lb≤1.10 with respect to the circumferential length Lb (see FIG. 5) of the side block 4 and is preferably in the range 0.90≤L2/Lb≤1.00. The lower limit described above ensures the mud discharge effect of the side block 4, and ensures the effect of reinforcing the rigidity of the tire side portion by the long portion 42. The upper limit described above prevents a decrease in the degree of freedom of tire deformation due to the long portion 42 becoming excessively large.

For example, in the configuration of FIG. 6, the long portion 42 of the side block 4 curves in one direction in the tire circumferential direction from the tire ground contact edge T toward the inner side in the tire radial direction as described above and thus extends across the two shoulder blocks 312A, 312B in the tire circumferential direction. Additionally, the long portion 42 extends to the inner side in the tire radial direction than the short portion 41. Thus, the radial height H2 of the long portion 42 is equal to the radial height Hb of the side block 4 (H2=Hb). This ensures the extension length of the long portion 42.

Furthermore, in FIG. 6, a radial height H1 of the short portion 41 is in the range 0.50≤H1/H2≤0.95 with respect to the radial height H2 of the long portion 42 and is preferably in the range 0.70≤H1/H2≤0.90. The lower limit described above ensures the mud discharge effect of the side block 4. The upper limit described above prevents a decrease in the degree of freedom of tire deformation due to the short portion 41 becoming excessively large.

For example, in the configuration of FIG. 6, the short portion 41 of the side block 4 is curved in the same direction as the long portion 42 from the tire ground contact edge T toward the inner side in the tire radial direction as described above, and thus protrudes in one direction in the tire circumferential direction (left side in FIG. 6). Additionally, the short portion 41 is connected to the radially inner side of the curved shape of the long portion 42. Accordingly, the side block 4 has a Y shape as a whole.

Additionally, as illustrated in FIG. 6, the side block 4 has a slit 43 that defines the connection portion of the short portion 41 and the long portion 42. The slit 43 is a narrow groove, a sipe, or a kerf formed on the surface of the side block 4, and penetrates through the side block 4. In the configuration of FIG. 6, the short portion 41 and the long portion 42 are defined by the extending portion of the shoulder lug groove 311B, forming the Y-shaped bifurcated portion of the side block 4, and the connection portion of the short portion 41 and the long portion 42 is defined by the narrower slit 43. Additionally, the slit 43 further extends the extending portion of the shoulder lug groove 311B, and extends through the top portion of the side block 4 in the longitudinal direction of the long portion 42.

In the configuration described above, the slit 43 defines the connection portion of the short portion 41 and the long portion 42 and extends through the side block 4, and thus discharge of the mud entering the Y-shaped bifurcated portion (in the configuration of FIG. 6, the extending portion of the shoulder lug groove 311B) of the side block 4 is promoted when the tire is rolling. This improves the mud performance of the tire.

Additionally, in FIG. 6, a width Ws of the slit 43 is in the range 0.01≤Ws/WgB≤0.60 with respect to a groove width WgB of the lug groove (in FIG. 6, the extending portion of the shoulder lug groove 311B) defining the short portion 41 and the long portion 42 and is preferably in the range 0.04≤Ws/WgB≤0.40. Additionally, the width Ws of the slit 43 is in the range 0.4 mm≤Ws≤7.0 mm and is preferably in the range 2.0 mm≤Ws≤5.0 mm. The lower limit described above ensures the width Ws of the slit 43, ensuring the effect of improving the mud discharge properties by the slit 43. The upper limit described above prevents a decrease in rigidity of the side block 4 due to the slit 43 becoming wider.

The width Ws of the slit 43 is measured as an opening width at the top surface of the side block 4 and the connection portion of the short portion 41 and the long portion 42.

The groove width WgB of the lug groove defining the short portion 41 and the long portion 42 is measured with the corner portions of the short portion 41 and the long portion 42 on the outer side in the tire radial direction as end points. In a configuration in which the lug groove includes a partial notch portion or a chamfered portion on the tire ground contact edge T (not illustrated), the groove width is measured with intersection points between an extension line of the top surface of the side block and extension lines of the groove walls as measurement points, in a cross-sectional view parallel with the groove width direction and the groove depth direction. Note that in the configuration of FIG. 5, the short portion 41 and the long portion 42 extend to the tire ground contact edge T, and thus the groove width WgA is equal to the groove width W11 (see FIG. 3) of the shoulder lug groove 311B at the tire ground contact edge T.

Additionally, a depth Hs of the slit 43 (not illustrated) is in the range 20% or more and 100% or less with respect to the height Hp (see FIG. 3) of the side block 4 at the arrangement position of the slit 43. The lower limit described above ensures the depth Hs of the slit 43, ensuring the effect of improving the mud discharge properties by the slit 43. The upper limit described above prevents a decrease in rigidity of the side block 4 due to the slit 43 becoming excessively deep.

Additionally, in FIG. 6, an inclination angle θs of the slit 43 with respect to the tire circumferential direction is in the range 40 degrees≤θs≤90 degrees and is preferably in the range 60 degrees≤θs≤85 degrees. The lower limit described above ensures the effect of promoting the mud discharge properties by the slit 43, and the upper limit described above ensures the rigidity of the side block 4.

The inclination angle θs of the slit 43 is measured as an angle formed by an imaginary straight line connecting both ends of the slit 43 and an imaginary straight line parallel with the tire radial direction. Additionally, as illustrated in FIG. 6, the inclination angle θs of the slit 43 is defined as positive in the same direction with respect to the inclination direction of the long portion 42 of the side block 4 toward the outer side in the tire radial direction.

Furthermore, in FIG. 6, a circumferential length Ls of the slit 43 is in the range 0.10≤Ls/Lb≤0.60 with respect to the circumferential length Lb of the side block 4 (see FIG. 5) and is preferably in the range 0.20≤Ls/Lb≤0.40. The lower limit described above ensures the effect of promoting the mud discharge properties by the slit 43, and the upper limit described above ensures the rigidity of the side block 4.

### Effect

As described above, [1] the tire 1 includes a plurality of side blocks 4 arrayed at a predetermined interval in the tire circumferential direction in the buttress portion (see FIGS. 4 and 5). Further, the side block 4 has the short portion 41 and the long portion 42 arrayed in a Y shape, and the slit 43 that defines the connection portion of the short portion 41 and the long portion 42 and is disposed with the Y-shaped top portion facing toward the inner side in the tire radial direction (see FIGS. 5 and 6).

In such a configuration, (1) in a plan view of the buttress portion, the side block 4 has a Y shape formed of the short portion 41 and the long portion 42, and thus the total length of the edge portion of the side block 4 increases compared to a configuration in which the side block is formed of a pair of small blocks having the same length (so-called V shape, which is not illustrated), improving the mud discharge effect of the side block 4 to improve the tire mud performance. Additionally, the rigidity of the side block 4 in the tire circumferential direction is reinforced by the long portion 42, improving the cut resistance performance of the tire. Additionally, (2) the slit 43 defines the connection portion of the short portion 41 and the long portion 42 and extends through the side block 4, and thus discharge of the mud entering the Y-shaped bifurcated portion (in the configuration of FIG. 6, the extending portion of the shoulder lug groove 311B) of the side block 4 is promoted when the tire is rolling, improving the tire mud performance. This has the advantage of providing the mud performance and cut resistance performance of the tire in a compatible manner.

Additionally, [2] the tire 1 has the same configuration as the tire 1 of the above-described [1] except that the circumferential length Lb of the side block 4 at the tire ground contact edge T is in the range 0.50≤Lb/Pb≤1.00 with respect to the pitch length Pb of the side block 4 (see FIG. 5). The lower limit described above has the advantage of ensuring the circumferential length Lb of the side block 4, ensuring the effect of improving the cut resistance and the mud discharge properties by the side block 4. Further, the upper limit described above has the advantage of preventing a decrease in the degree of freedom of tire deformation due to the side block 4 becoming excessively large, ensuring the ground contact characteristics of the tire.

Additionally, [3] the tire 1 has the same configuration as the tire 1 of the above-described [1] or [2] except that the radial height Hb of the side block 4 is in the range 0.20≤Hb/SH≤0.50 with respect to the tire cross-sectional height SH (see FIG. 5). The lower limit described above has the advantage of ensuring the radial height Hb of the side block 4, ensuring the effect of improving the cut resistance and the mud discharge properties by the side block 4. Further, the upper limit described above has the advantage of preventing a decrease in the degree of freedom of tire deformation due to the side block 4 becoming excessively large, ensuring the ground contact characteristics of the tire.

Additionally, [4] the tire 1 has the same configuration as the tire 1 of any one of the above-described [1] to [3] except that the circumferential length Lb of the side block 4 at the tire ground contact edge Tis in the range 0.70≤Lb/Hb≤1.50 with respect to the radial height Hb of the side block 4 (see FIG. 5). This has the advantage of properly setting the aspect ratio of the side block, ensuring the effect of improving the cut resistance and the mud performance of the tire by the side block 4.

Additionally, [5] the tire 1 has the same configuration as the tire 1 of any one of the above-described [1] to [4] except that the circumferential distance Dp of adjacent side blocks 4, 4 is in the range 0.10≤Dp/WgA≤1.00 with respect to the groove width WgA of the lug groove (extension portion of the shoulder lug groove 311A in FIG. 5) defining the adjacent side blocks 4, 4 (see FIG. 5). The lower limit described above has the advantage of ensuring the circumferential distance Dp of the side block 4, ensuring the effect of improving the cut resistance and the mud discharge properties by the side block 4. Additionally, the upper limit described above has the advantage of preventing a decrease in the degree of freedom of tire deformation due to the side block 4 becoming overcrowded, ensuring the ground contact characteristics of the tire.

Additionally, [6] the tire 1 has the same configuration as the tire 1 of any one of the above-described [1] to [5] except that the circumferential length L2 of the long portion 42 (see FIG. 6) is in the range 0.80≤L2/Lb≤1.10 with respect to the circumferential length Lb of the side block 4 (see FIG. 5). The lower limit described above has the advantage of ensuring the mud discharge effect of the side block 4, ensuring the effect of reinforcing the rigidity of the tire side portion by the long portion 42. The upper limit described above has the advantage of preventing a decrease in the degree of freedom of tire deformation due to the long portion 42 becoming excessively large.

Additionally, [7] the tire 1 has the same configuration as the tire 1 of any one of the above-described [1] to [6] except that the radial height H1 of the short portion 41 is in the range 0.50≤H1/H2≤0.95 with respect to the radial height H2 of the long portion 42 (see FIG. 6). The lower limit described above has the advantage of ensuring the mud discharge effect of the side block 4. The upper limit described above has the advantage of preventing a decrease in the degree of freedom of tire deformation due to the short portion 41 becoming excessively large.

Additionally, [8] the tire 1 has the same configuration as the tire 1 of any one of the above-described [1] to [7] except that the short portion 41 and the long portion 42 are connected to the tire ground contact edge T (see FIG. 6). Such a configuration has the advantage of increasing the mud discharge effect of the side block 4 and the effect of reinforcing the rigidity compared to a configuration in which the short portion 41 and the long portion 42 are separated from the tire ground contact edge T (not illustrated).

Additionally, [9] the tire 1 has the same configuration as the tire 1 of any one of the above-described [1] to [8] except that the long portion 42 has a shape curved or bent in one direction in the tire circumferential direction from the tire ground contact edge T toward the inner side in the tire radial direction (see FIG. 6). This has the advantage of ensuring the extension length of the long portion 42.

Additionally, [10] the tire 1 has the same configuration as the tire 1 of any one of the above-described [1] to [9] except that the width Ws of the slit 43 is in the range 0.01≤Ws/WgB≤0.60 with respect to the groove width WgB of the lug groove defining the short portion 41 and the long portion 42 (see FIG. 6). The lower limit described above has the advantage of ensuring the width Ws of the slit 43, ensuring the effect of improving the mud discharge properties by the slit 43. The upper limit described above has the advantage of preventing the decrease in rigidity of the side block 4 due to the slit 43 becoming wider.

Additionally, [11] the tire 1 has the same configuration as the tire 1 of any one of the above-described [1] to [10] except that the inclination angle θs of the slit with respect to the tire circumferential direction is in the range 40 degrees≤θs≤90 degrees (see FIG. 6). The lower limit described above has the advantage of ensuring the effect of promoting the mud discharge properties by the slit 43, and the upper limit described above ensures the rigidity of the side block 4.

Additionally, [12] the tire 1 has the same configuration as the tire 1 of any one of the above-described [1] to [11] except that the circumferential length Ls of the slit 43 (see FIG. 6) is in the range 0.10≤Ls/Lb≤0.60 with respect to the circumferential length Lb of the side block 4 (see FIG. 5). The lower limit described above has the advantage of ensuring the effect of promoting the mud discharge properties by the slit 43, and the upper limit described above ensures the rigidity of the side block 4.

### Target of Application

In this embodiment, as described above, a pneumatic tire is described as an example of a tire. However, no such limitation is intended, and the configurations described in the embodiments can also be applied to other tires in a discretionary manner within the scope apparent to one skilled in the art. Examples of other tires include an airless tire, and a solid tire.

### Examples

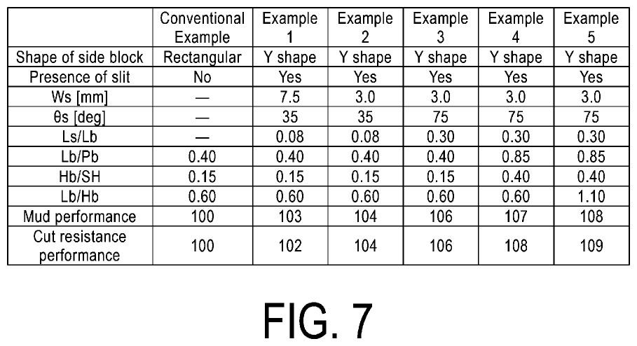

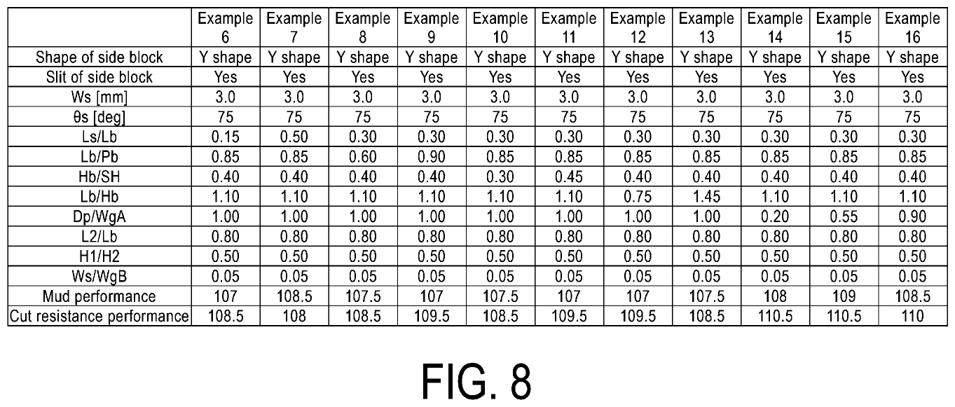

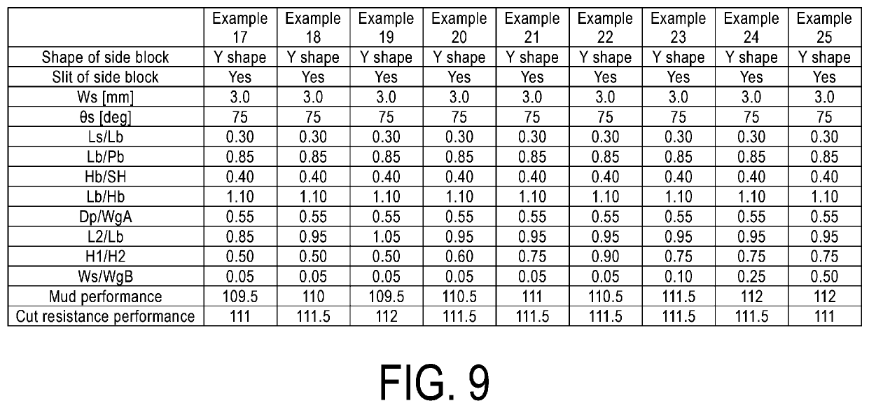

FIGS. 7 to 9 are tables showing the results of performance tests of tires according to an embodiment of the technology.

In the performance tests, (1) mud performance and (2) cut resistance performance were evaluated for a plurality of types of test tires. Further, test tires having a tire size of LT265/70R17 121Q were mounted on rims having a rim size of 17×8 J, and an internal pressure of 450 kPa and a load specified by JATMA were applied to the test tires. Further, the test tires were mounted on all wheels of an LT pickup car serving as a test vehicle.

(1) In the evaluation related to mud performance, the test vehicle traveled on a predetermined mud road, and the test driver performed a sensory evaluation related to traction characteristics. The evaluation was conducted using index values, with Conventional Example being assigned as the reference (100), with larger values being more preferable.

(2) In the evaluation related to cut resistance performance, the test vehicle traveled 8000 km on a predetermined off-road durability road, and then the external damage generated in the buttress portion of the tire was observed. Then, the results are expressed as index values and evaluated, with Conventional Example being assigned as the reference (100). In this index value evaluation, larger values are preferable.

The test tire of Example includes the configurations of FIGS. 1, 4, and 5, and one side block 4 has a Y shape formed of a short portion 41 and a long portion 42, and also the connection portion of the short portion 41 and the long portion 42 includes the slit 43. Further, the tire cross-sectional height SH is 183 mm, the groove width W11 of the shoulder lug grooves 311A, 311B is 17.4 mm, and the groove depth H11 is 14.6 mm. Additionally, the pitch length Pb of the side block 4 is 105 mm, and the radial height Hb of the side block 4 is 65 mm. Additionally, the maximum height Hp of the side block 4 is 5.0 mm.

The test tire of Comparative Example has the same configuration as the test tire of Example 1 except that one side block is formed of one rectangular block and does not have a slit.

As can be seen from the test results, the test tires of Examples provide mud performance and cut resistance performance of a tire in a compatible manner.

1. A tire, comprising
a plurality of side blocks arrayed at a predetermined interval in a tire circumferential direction in a buttress portion,
the side blocks comprising a short portion and a long portion arrayed in a Y shape and a slit that defines a connection portion of the short portion and the long portion and being disposed with a top portion of the Y shape facing toward an inner side in a tire radial direction.

2. The tire according to claim 1, wherein a circumferential length Lb of the side blocks at a tire ground contact edge is in a range 0.50≤Lb/Pb≤1.00 with respect to a pitch length Pb of the side blocks.

3. The tire according to claim 1, wherein a radial height Hb of the side blocks is in a range 0.20≤Hb/SH≤0.50 with respect to a tire cross-sectional height SH.

4. The tire according to claim 1, wherein a circumferential length Lb of the side blocks at a tire ground contact edge is in a range 0.70≤Lb/Hb≤1.50 with respect to a radial height Hb of the side block.

5. The tire according to claim 1, wherein a circumferential distance Dp of the side blocks adjacent to each other is in a range 0.10≤Dp/WgA≤1.00 with respect to a groove width WgA of a lug groove that defines the side blocks adjacent to each other.

6. The tire according to claim 1, wherein a circumferential length L2 of the long portion is in a range 0.80≤L2/Lb≤1.10 with respect to a circumferential length Lb of the side blocks.

7. The tire according to claim 1, wherein a radial height H1 of the short portion is in a range 0.50≤H1/H2≤0.95 with respect to a radial height H2 of the long portion.

8. The tire according to claim 1, wherein the short portion and the long portion are connected to a tire ground contact edge.

9. The tire according to claim 1, wherein the long portion has a shape that is curved or bent in one direction in a tire circumferential direction from a tire ground contact edge toward an inner side in a tire radial direction.

10. The tire according to claim 1, wherein a width Ws of the slit is in a range 0.01≤Ws/WgB≤0.60 with respect to a groove width WgB of a lug groove that defines the short portion and the long portion.

11. The tire according to claim 1, wherein an inclination angle θs of the slit with respect to the tire circumferential direction is in a range 40 degrees≤θs≤90 degrees.

12. The tire according to claim 1, wherein a circumferential length Ls of the slit is in a range 0.10≤Ls/Lb≤0.60 with respect to a circumferential length Lb of the side blocks.
